(19) United States
(12) Patent Application Publication
(10) Pub. No.: US 2026/0253175 A1
(43) Pub. Date: Aug. 27, 2026

(54) INFRASTRUCTURE TO COMPRESS AND FUSE SENSOR DATA

(71) Applicant: Dell Products L.P., Round Rock, TX (US)

(72) Inventors: Michael Robillard, Shrewsbury, MA (US); Karim Elghamry, Co. Cork (IE); Ramona Devi, San Jose, CA (US); Xuebin He, Westwood, MA (US); Trevor Scott Conn, Leander, TX (US); Rushiv Arora, Boston, MA (US)

(21) Appl. No.: 19/066,038

(22) Filed: Feb. 27, 2025

(51) Int. Cl. G06T 5/50; G06T 5/60; G06T 9/00

(52) U.S. Cl. CPC G06T 5/50; G06T 5/60; G06T 9/00; G06T 2207/20221

(57) ABSTRACT

A method for compressing and fusing sensor data. One example method includes collecting, by a sensor, data concerning an environment in which the sensor is located, compressing the data to generate compressed data, filtering the compressed data, fusing the compressed data with other data collected by another sensor to generate fused data, and transmitting and/or storing the fused data. The sensor may be a stereo camera, and the compressing may involve reducing a frame capture rate of the stereo camera.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to data processing and management. More particularly, at least some embodiments relate to systems, hardware, software, computer-readable media, and methods, for compressing, and/or fusing, data for transmission and processing.

### BACKGROUND

In the present era of so-called ‘big data,’ the relentless advancement of technology has led to the proliferation of devices such as sensors that continuously gather vast amounts of information, both day and night. However, whether it is in the context of smart cities, autonomous vehicles, or industrial processes, the data collected is often too extensive to manage effectively through conventional approaches.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1a discloses aspects of an example infrastructure, according to one embodiment.

FIG. 1b discloses aspects of an example architecture, according to one embodiment.

FIG. 1c discloses aspects of an example schema, according to one embodiment.

FIG. 2 discloses aspects of a method, according to one embodiment.

FIG. 3 discloses aspects of a computing entity configured and operable to perform any of the disclosed methods, processes, and operations.

### DETAILED DESCRIPTION OF SOME EXAMPLE EMBODIMENTS

Embodiments disclosed herein generally relate to data processing and management. More particularly, at least some embodiments relate to systems, hardware, software, computer-readable media, and methods, for compressing, and/or fusing, data for transmission and processing.

One or more example embodiments embrace infrastructure, methods, systems, and devices, that may operate to gather, compress, and fuse, data. This data may be transmitted to other infrastructure, methods, systems, and devices, for operations including processing and analysis.

A method according to one embodiment may comprise operations including, but not limited to: using one or more devices, such as sensors and/or cameras, to gather data; compressing the data by using procedural code to adjust a rate at which the data is gathered, and/or, subsequently transmitted; filtering the data; fusing a first portion of the data with a second portion of the data; and, transmitting the data to a recipient.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that data compression may be used to reduce transmission bandwidth and storage requirements. In an embodiment, data may be fused for use by generative AI systems in making inferences and performing other processes. In an embodiment, data may be fused to provide richer context than would be available from the unfused data. In an embodiment, an AI/ML model, or simply ‘model,’ herein, may employ techniques to extract specific information from a dataset. In an embodiment, a model such as an AI/ML model may generate a distilled, focused, data set from a raw video feed so as to capture essential aspects of the data while reducing transmission bandwidth and data storage requirements. In an embodiment, a model may sift through, summarize, and extract relevant information from a volume of data. Various other advantages of one or more example embodiments will be apparent from this disclosure.

### A. CONTEXT FOR ONE OR MORE EMBODIMENTS FOR ONE EMBODIMENT

The following is a discussion of aspects of a context for various embodiments. This discussion is not intended to limit the scope of the claims or this disclosure, or the applicability of the embodiments, in any way.

### A.1 Introduction

The retail industry is undergoing a profound transformation driven by rapidly changing consumer preferences, technological advancements, and increasing competition. To remain relevant and competitive in this dynamic landscape, retail enterprises face the challenge of finding innovative ways to engage customers, reduce transactional friction, enhance their shopping experiences, build their brands, and drive business transformation.

This disclosure encompasses a variety of areas. These include, but are not necessarily limited to: product visualization, virtual try-on, store optimization, consumer privacy, and interactive kiosks. By leveraging these technologies, retailers can cater to the increasing demands of tech-savvy consumers who seek convenient, immersive, and informative shopping encounters.

One or more embodiments may involve what are sometimes referred to as data network effects. For example, processes, infrastructure, and algorithms may be used to generate data network effects. A data network effect refers to the situation where the value of a system increases as more data accumulates within it. Realistic creation of data network effects may be attained by automatically capturing and processing contextualized data. Data network effects are commonly leveraged in generative AI systems.

Generative AI requires large datasets that must be kept fresh through back-and-forth customer interactions, such as with a virtual assistant for example. To remain competitive, an AI operator must collect data, analyze it, offer predictions, and then seek feedback, such as from one or more users, to sharpen subsequent suggestions. The value of generative AI systems depends on the data that is automatically collected from users. The generative AI system performance—its ability to accurately predict and suggest—thus hinges on the economic principle referred to as data network effects.

Useful bits of data can be found everywhere, as an example, data may come from interactions with buyers, suppliers, and coworkers. A retailer, for example, could track what consumers looked at, what they placed in their cart, and what they ultimately paid for. These minute, seemingly trivial details can vastly improve the predictions of a generative AI system. In order for this data to be useful, it must be collected, compressed, and fused with other sensor solutions to provide context.

This data will not be sourced from humans pounding keyboards. It will, instead, be sensed via cameras and other high-resolution sensors and processed using “Distributed ML” or “Field AI” on tailored infrastructure.

### A.2 Example Aspects of Various Embodiments

It is expected that immersive technology will become a key enabler of business transformation because it enables humans to interact with business information persisted in datastores, machinery represented as digital twins, and artificial intelligence easily and as equals. This idea may be referred to as the immersive enterprise. This disclosure defines an immersive enterprise as a business that leverages immersive technology to perform business transformation. This idea is aligned with what some in the industry define as spatial computing.

Within spatial or immersive environments, the ability to model and improve business processes is only constrained by the processing capabilities of the underlying infrastructure. Thus, an embodiment can leverage real-world physics, or not. An embodiment may make a simulated environment track real time operations or replay the past. Historical analysis, exploratory planning, and new product introduction all become easier. Having these capabilities available to the average business has never happened before. It has the potential to dramatically improve businesses and to reduce transactional friction.

One example embodiment, discussed elsewhere herein, is focused on the retail vertical. However, it is noted that the concepts disclosed herein are largely transferable or applicable to other verticals.

### B. DETAILED DISCUSSION OF ASPECTS OF ONE OR MORE EMBODIMENTS

### B.1 Introduction

One or more embodiments concern a variety of contexts and applications, aspects of which are disclosed in United States Patent Appl., atty. docket 16192.1162, entitled INFRASTRUCTURE TO VIRTUALLY REPRESENT A RETAIL STORE, filed the same day herewith and incorporated herein in its entirety by this reference. Some contexts and applications include, but are not limited to, data compression such as in the context of virtual environments for example, business transformation through the utilization of interactive screens, retail store optimization using inventory robots, automated self-return systems, robotic carts, and implementing theft and fall detection measures, device optimization—which may entail camera and physical display calibration and management, and methods useful for creating multiple virtual representation of a physical space that individually and collectively generate actionable information.

To deal with the issue of explosive data growth such as may occur in connection with the aforementioned systems and processes, artificial intelligence models have emerged as a potent solution. These AI algorithms are adept at processing and compressing the incoming data streams to extract only the relevant information, thereby alleviating the problem of data deluge.

Thus, a data management approach according to one embodiment may comprise the use of stereo cameras equipped with advanced AI models. These cameras capture continuous video feeds, and AI techniques like depth sensing and object detection are employed to extract essential information. By identifying and tracking objects in the scene, these models generate bounding boxes around individuals and provide data on their position and velocity. This information, which is much more concise and meaningful than raw video feeds, can be efficiently stored and utilized for various applications, such as security monitoring or traffic management. In essence, it exemplifies how AI-driven data processing helps solve the challenges posed by the massive influx of data in our modern world.

Ultimately, in the era of big data, the synergy between sensors and AI models, according to disclosed embodiments, offers a promising solution to the data deluge problem. By applying artificial intelligence to the task of sifting through, summarizing, and extracting relevant information from the data flood, embodiments may not only reduce storage and computational demands but also unlock new insights and opportunities across various domains, enabling better, data-informed decisions in real-time.

### B.2 Overview

One or more embodiments may have various capabilities, although no embodiment is required to have any particular capability, or capabilities. Some example capabilities of one or more embodiments include, but are not limited to:
1. The ability to use stereo cameras which offer depth perception, enabling more advanced data processing
2. The ability to deploy AI models running real time enabling immediate data extraction and analysis
3. The ability to track and position precisely by extracting global coordinates of individuals
4. The ability to draw bounding boxes around detected objects adds a layer of visual context and enhances the information extracted.
5. The use of additional filters to retain data specifically for individual closest to the camera.
6. The integration of Google® Mediapipe to detect hand landmarks and enable gesture recognition for interactive purposes.
7. The use of procedural code to adjust the frames per second (fps) dynamically based on the requirement
8. The ability to use local processing to achieve a substantial reduction in data size through data compression, thus making data storage and transmission more efficient and, in some cases, more economically feasible.
9. The ability to fuse data using local processing to develop contextual information from multiple sensors. As an example, camera and radio telemetry can be combined to identify particular users in a manner that meets local privacy requirements. This fused data is particularly valuable for upstream generative AI systems.

### B.3 Detailed Discussion of Aspects of an Embodiment

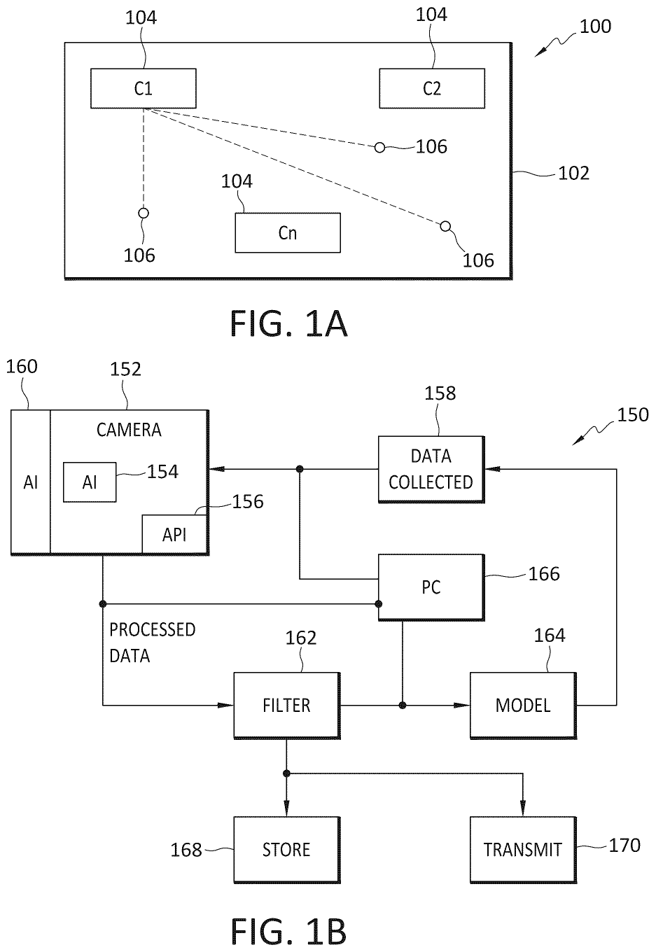

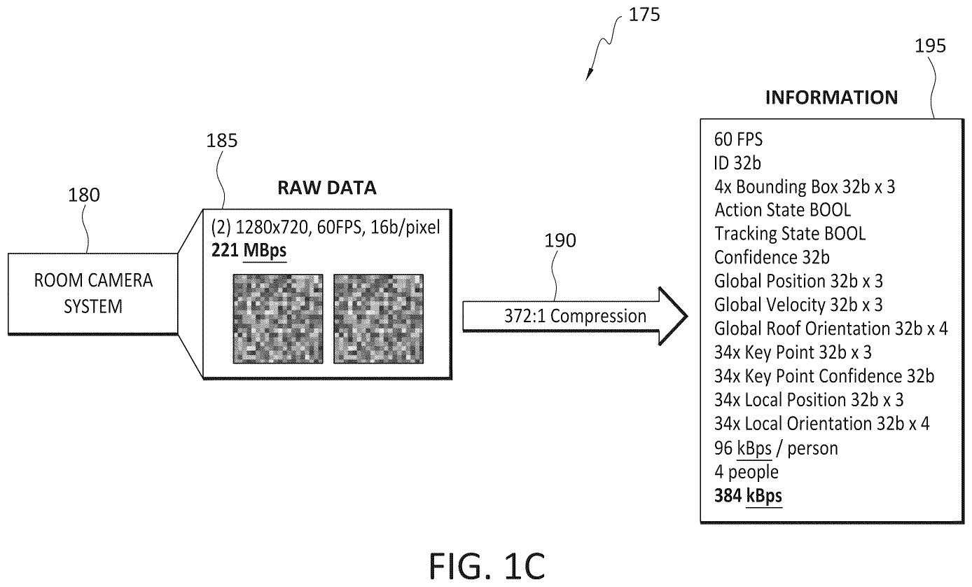

In an embodiment, various operations may be performed. With attention now to FIG. 1a, aspects of an example infrastructure 100 for an embodiment are disclosed. An embodiment may be implemented at least in part in a physical space 102, such as a room for example. The physical space 102 may be physically bounded, such as by walls for example, and/or may be arbitrarily defined using coordinates of a local, or global, coordinate system.

Within the physical space 102, various sensors, such as stereoscopic cameras 104 for example, may be deployed. Any number and type of sensors may be employed in a particular physical space. It is noted that as used herein, a ‘sensor’ embraces, but is not limited to, hardware, software, or a combination of hardware, operable to gather data concerning an environment where the sensor is deployed.

One or more of the cameras 104, and/or other sensors, may detect, and record information concerning, one or more entities 106 in the physical space 102. In an embodiment, an entity 106 may comprise a human, who may be moving around in the physical space 102, but the scope of this disclosure is not limited to human entities. Another example of an entity 106 is an autonomous vehicle, or other object. A camera 104, or other sensor(s), may comprise, or at least communicate with, one or more AI models, each of which may be specialized to perform particular functions concerning data gathered by the cameras 104 and/or by other sensors. Some examples of such AI models are discussed below.

Turning now to FIG. 1b, details are provided concerning an example architecture 150 according to one embodiment. The architecture 150 may employ the elements of the infrastructure 100 disclosed in FIG. 1a.

As shown in FIG. 1b, a sensor such as a camera 152 may be integrated with one or more AI models 154 that run in the background using an API (application program interface) 156 of the camera 152. The camera 152 may collect data 158, which may comprise audio, video, and still images, for example. The AI model 154 may extract, from the data 158, information including, but not limited to, global coordinates of entities within a physical space, as depicted in FIG. 1a, as well as a headcount of the total entities in the physical space, and bounding boxes around detected entities. Another AI model 160, which may be dedicated to depth sensing analysis performed on the data 158, may be layered on top of the camera 152 and related components to pinpoint a location, and possibly identification, of the entity closest to, relative to other entities in the physical space, a screen or lens of the camera 152.

Information extracted from the data 158 by the AI model 154, and processed by the AI model 160 may be further refined by application of a filter 162. In an embodiment, the filter 162 is applied to the processed data to retain information specifically for those individuals closest to the camera 152. This refined data may then be passed through a model 164, such as the Google® MediaPipe model, which may operate, in one embodiment, to detect ‘landmarks’ on the hand of a user in a physical space, so as to enable gesture recognition with respect to that particular user.

With continued reference to the example of FIG. 1b, procedural code 166, which may comprise procedural programming, may be employed to perform a data compression process on the data 158, the information extracted from the data 158, the processed data, data processed by the AI models 154 and/or 160, the data refined by the filter 162, and the data passed through—and processed by—the model 164. Thus, in the example of FIG. 1b, any data and/or metadata, whether raw or processed, may be compressed using the procedural code 166.

Various forms and implementations of data compression may be performed, and the scope of this disclosure is not limited to any particular type of data compression. In the illustrative, but non-limiting, context of data gathering by a camera, data compression may comprise, for example, reducing the number of frames per second captured, and/or retained, by the camera 152. Additionally, or alternatively, after the data 158 has been captured by the camera 152, the captured data may be processed by reducing the number of frames in a given data sample. For example, if raw data 158 captured by the camera 152 has 60 frames per second, that data may be down-sampled to 20 frames per second, in effect, compressing the captured data 158. Data compression by reducing frames per second capture may be quite effective. For example, reducing capture from 60 frames per second to about 4 frames per second may result in a data amount reduction from 111 MB/s to only 8 MB/s.

Data compression according to an embodiment may have various benefits. For example, the compressed data may take up significantly less space in a data store 168. As well, it may take relatively less time to transmit 170 the compressed data since the communication bandwidth needed may be significantly smaller than what would be needed for uncompressed data.

Turning next to the example of FIG. 1c, an example schema 175 according to one embodiment is disclosed in which data compression is performed using a room camera system 180. In particular, the room camera system 180, and/or other sensor(s), may capture data 185 in raw form. The raw data 185 may be compressed using various data compression techniques, examples of which are disclosed herein. Finally, various information, which may comprise data and metadata, collectively indicated at 195, may be extracted from the compressed, raw data 185. As shown, the information 195 may comprise a wide variety of things including, but not limited to, frame capture rate (60 fps), bounding box sizes and locations, position, movement, and orientation of an entity in a physical space, a headcount (4) for a physical space, and a compressed or reduced frame capture rate (384 kBps).

### C. EXAMPLE METHODS

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

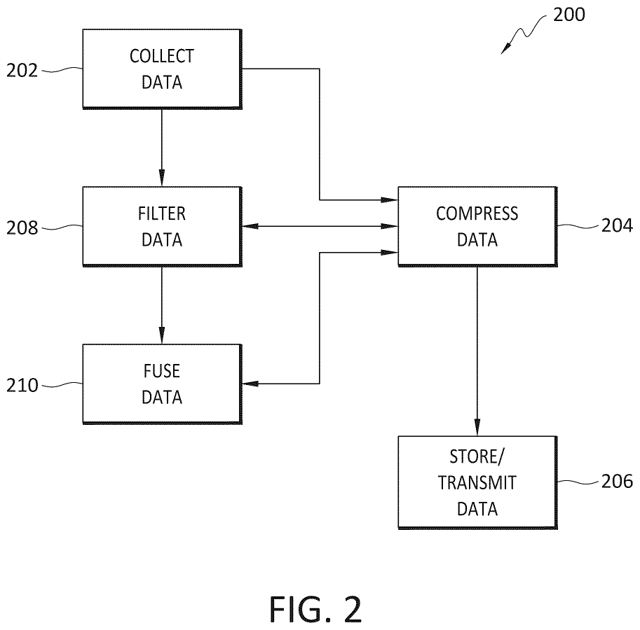

Directing attention now to FIG. 2, a method 200 according to one embodiment is disclosed. The example method 200 may begin with the collection 202 of data, by one or more sensors, such as cameras, located in a physical space. In an embodiment, the collected data may then be compressed 204, and possibly stored and/or transmitted 206.

Additionally, or alternatively, after the data has been collected 202, the data may then be filtered 204. The filtered data may then be compressed 204, and possibly stored and/or transmitted 206. In an embodiment, the filtered data may be fused 210 with other data and then compressed 204, and possibly stored and/or transmitted 206.

As shown in the example of FIG. 2, data that has been compressed 204 may subsequently be filtered 208 and/or fused 210. Thus, the compression 204, filtering 208, and fusing 210, may be performed in any combination, and in any order. Moreover, all of these operations need not be performed in every embodiment. By way of illustration, the filtering 208 and/or fusing 210 may be omitted in some embodiments. Thus, the method 200 disclosed in FIG. 2 is presented only by way of example, and is not intended to limit the scope of this disclosure, or of any claims, in any way.

### D. EXAMPLE USE CASES FOR ONE OR MORE EMBODIMENTS

Following are some example use cases for one or more embodiments. These are provided only by way of illustration and are not intended to limit the scope of this disclosure, or of any claims, in any way.

### D.1 Example 1—Video Streaming and Surveillance

Video streaming platforms and surveillance systems often deal with large volumes of video data. Data compression can significantly reduce the bandwidth and storage requirements. In the case of surveillance, this means that security cameras can continuously capture high-quality video while consuming less bandwidth and storage space, making it more cost-effective and efficient. Video streaming services can deliver content to users with faster load times and reduced buffering.

### D.2 Example 2—IoT and Sensor Networks

Internet of Things (IoT) devices and sensor networks generate massive amounts of data, especially in applications like smart cities, environmental monitoring, and industrial automation. Data compression helps in transmitting this data over limited network bandwidth effectively. For instance, sensors collecting environmental data in remote areas can send compressed data to central servers without overburdening the available network resources. This technique makes IoT systems more scalable and cost-efficient.

### D.3 Example 3—Remote Sensing and Satellite Imaging

Remote sensing platforms, such as satellites and aerial drones, capture extensive imagery and data. Data compression may be important in these scenarios to reduce the volume of data that needs to be transmitted to ground stations or stored on board. This enables more efficient data transmission, reducing latency and making it feasible to gather and analyze data from remote locations. Researchers, environmental agencies, and disaster management teams can benefit from this by accessing timely and essential information.

### E. FURTHER EXAMPLE EMBODIMENTS

Following are some further example embodiments. These are presented only by way of example and are not intended to limit the scope of this disclosure or the claims in any way.

Embodiment 1. A method for compressing and fusing sensor data, comprising: collecting, by a sensor, data concerning an environment in which the sensor is located; compressing the data to generate compressed data; filtering the compressed data; fusing the compressed data with other data collected by another sensor to generate fused data; and transmitting and/or storing the fused data.

Embodiment 2. The method as recited in any preceding embodiment, wherein the sensor comprises a stereo camera, and the compressing comprises lowering a frame capture rate of the camera.

Embodiment 3. The method as recited in any preceding embodiment, wherein an AI (artificial intelligence) model is used to extract insights from the data.

Embodiment 4. The method as recited in any preceding embodiment, wherein the sensor comprises a stereo camera, and bounding boxes are drawn around one or more objects detected by the stereo camera.

Embodiment 5. The method as recited in any preceding embodiment, wherein the sensor comprises a stereo camera, and a filter is applied to the data so that a portion of the data that is specific to a person closest, relative to one or more other persons, to the camera is retained.

Embodiment 6. The method as recited in any preceding embodiment, wherein the sensor comprises a stereo camera, and the data is processed by an AI model to enable gesture recognition of a human gesture, by way of the stereo camera.

Embodiment 7. The method as recited in any preceding embodiment, wherein the compressing is adjusted dynamically according to one or more parameters including a position, orientation, and speed of an object tracked by the sensor.

Embodiment 8. The method as recited in any preceding embodiment, wherein the compressing is performed locally at the sensor.

Embodiment 9. The method as recited in any preceding embodiment, wherein the fusing is performed locally at the sensor.

Embodiment 10. The method as recited in any preceding embodiment, wherein the compressed data is obtained by a stereo camera, and the other data comprises radio telemetry data.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

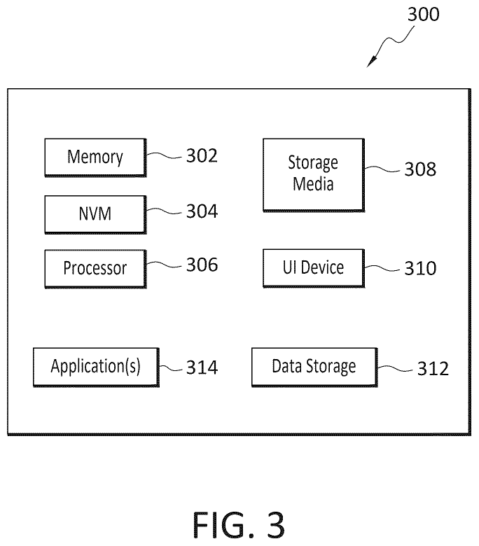

With reference briefly now to FIG. 3, any one or more of the entities disclosed, or implied, by FIGS. 1a-2, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for compressing and fusing sensor data, comprising:
collecting, by a sensor, data concerning an environment in which the sensor is located;
compressing the data to generate compressed data;
filtering the compressed data;
fusing the compressed data with other data collected by another sensor to generate fused data; and
transmitting and/or storing the fused data.

2. The method as recited in claim 1, wherein the sensor comprises a stereo camera, and the compressing comprises lowering a frame capture rate of the camera.

3. The method as recited in claim 1, wherein an AI (artificial intelligence) model is used to extract insights from the data.

4. The method as recited in claim 1, wherein the sensor comprises a stereo camera, and bounding boxes are drawn around one or more objects detected by the stereo camera.

5. The method as recited in claim 1, wherein the sensor comprises a stereo camera, and a filter is applied to the data so that a portion of the data that is specific to a person closest, relative to one or more other persons, to the camera is retained.

6. The method as recited in claim 1, wherein the sensor comprises a stereo camera, and the data is processed by an AI model to enable gesture recognition of a human gesture, by way of the stereo camera.

7. The method as recited in claim 1, wherein the compressing is adjusted dynamically according to one or more parameters including a position, orientation, and speed of an object tracked by the sensor.

8. The method as recited in claim 1, wherein the compressing is performed locally at the sensor.

9. The method as recited in claim 1, wherein the fusing is performed locally at the sensor.

10. The method as recited in claim 1, wherein the compressed data is obtained by a stereo camera, and the other data comprises radio telemetry data.

11. A non-transitory storage medium having stored therein instructions that are executable by one or more hardware processors to perform operations comprising:
collecting, by a sensor, data concerning an environment in which the sensor is located;
compressing the data to generate compressed data;
filtering the compressed data;
fusing the compressed data with other data collected by another sensor to generate fused data; and
transmitting and/or storing the fused data.

12. The non-transitory storage medium as recited in claim 11, wherein the sensor comprises a stereo camera, and the compressing comprises lowering a frame capture rate of the camera.

13. The non-transitory storage medium as recited in claim 11, wherein an AI (artificial intelligence) model is used to extract insights from the data.

14. The non-transitory storage medium as recited in claim 11, wherein the sensor comprises a stereo camera, and bounding boxes are drawn around one or more objects detected by the stereo camera.

15. The non-transitory storage medium as recited in claim 11, wherein the sensor comprises a stereo camera, and a filter is applied to the data so that a portion of the data that is specific to a person closest, relative to one or more other persons, to the camera is retained.

16. The non-transitory storage medium as recited in claim 11, wherein the sensor comprises a stereo camera, and the data is processed by an AI model to enable gesture recognition of a human gesture, by way of the stereo camera.

17. The non-transitory storage medium as recited in claim 11, wherein the compressing is adjusted dynamically according to one or more parameters including a position, orientation, and speed of an object tracked by the sensor.

18. The non-transitory storage medium as recited in claim 11, wherein the compressing is performed locally at the sensor.

19. The non-transitory storage medium as recited in claim 11, wherein the fusing is performed locally at the sensor.

20. The non-transitory storage medium as recited in claim 11, wherein the compressed data is obtained by a stereo camera, and the other data comprises radio telemetry data.
